(19) United States
(12) Patent Application Publication
(10) Pub. No.: US 2024/0367100 A1
(43) Pub. Date: Nov. 7, 2024

(54) METHODS OF CARBON DIOXIDE CAPTURE AND GEOLOGICAL STORAGE

(71) Applicant: Bal Mukund Dhar, Lincoln, MA (US)

(72) Inventor: Bal Mukund Dhar, Lincoln, MA (US)

(21) Appl. No.: 18/653,845

(22) Filed: May 2, 2024

Related U.S. Application Data
(60) Provisional application No. 63/499,523, filed on May 2, 2023.

(51) Int. Cl. B01D 53/62; B01D 53/14; B01D 53/78; B01D 53/86; C01D 7/10; E21B 41/00; E21B 43/28

(52) U.S. Cl. CPC B01D 53/62; B01D 53/1418; B01D 53/1475; B01D 53/1493; B01D 53/78; B01D 53/8671; C01D 7/10; E21B 41/0064; E21B 43/28; B01D 2252/10; B01D 2257/504; B01D 2258/06

(57) ABSTRACT

Embodiments described herein relate to a method of geological CO₂ storage via in-situ mineralization of trona, the method comprising injecting a mixture comprising CO₂ and H₂O in a geological formation comprising trona, wherein the H₂O dissolves a portion of trona to form sodium carbonate in solution, and the CO₂ reacts with the sodium carbonate to form sodium bicarbonate. Embodiments described herein further relate to a method of reactive absorption of CO₂ and its simultaneous mineralization in trona comprising, mining of trona rock via solution mining to form a trona solution, reacting an input gas mixture comprising CO₂ with the trona solution to form sodium bicarbonate. Embodiments described herein further relate to capture of carbon dioxide directly from air and storing it into solution mined trona as sodium bicarbonate.

### CROSS-REFERENCE TO RELATED APPLICATIONS

This application is a Utility Patent application claiming priority to U.S. Provisional Patent Application Ser. No. 63/499,523, filed on May 2, 2023, which is incorporated by reference herein in its entirety.

### BACKGROUND OF THE INVENTION

### 1) Field of the Invention

The invention relates to the field of carbon capture and storage, and more specifically to geological storage of carbon dioxide in trona, or other minerals comprising sodium carbonate by physical means or chemical storage. The invention also relates to simultaneous capture and mineralization of carbon dioxide from emissions sources or air into minerals comprising trona or other minerals comprising sodium carbonate.

### 2) Description of Related Art

Carbon capture and storage (CCS) and carbon removal technologies play crucial roles in mitigating anthropogenic carbon dioxide (CO₂) emissions and combating climate change. CCS involves capturing CO₂ emissions from industrial processes, such as power plants and factories, and storing them underground to prevent their release into the atmosphere. This process typically involves capturing CO₂ from large point sources, compressing it into a dense fluid, and injecting it into geological formations deep underground for long-term storage. Geological carbon storage via physical means relies on the impermeability and porosity of certain rock formations, such as depleted oil and gas reservoirs, saline aquifers, and deep coal seams, to trap and contain the injected CO₂.

However, while geological storage offers significant potential for large-scale CO₂ mitigation, there are concerns about its permanence. Geological formations must maintain their integrity over thousands of years to prevent CO₂ leakage back into the atmosphere, posing risks to human health and the environment. Additionally, the energy requirements for capturing, compressing, and transporting CO₂ to storage sites can be substantial, often leading to increased operational costs and energy consumption.

Carbon Removal via Direct air capture (DAC) represents a cutting-edge technology designed to mitigate climate change by actively removing carbon dioxide (CO₂) from the atmosphere. DAC systems utilize specialized sorbents or chemical reactions to selectively capture CO₂ molecules directly from ambient air. Once captured, the CO₂ is separated from the air stream and concentrated into a pure CO₂ stream for storage or utilization. DAC offers several advantages, including the potential for deployment in diverse locations and the ability to offset emissions from hard-to-abate sectors such as aviation or agriculture. However, DAC currently faces challenges related to high energy consumption, cost, and scalability, which require ongoing research and development efforts to address. Despite these challenges, DAC holds promise as a vital component of comprehensive climate change mitigation strategies, providing a pathway to achieve negative emissions and help combat the escalating threat of global warming.

The three-step schemes where CO₂ is first absorbed/adsorbed in a sorbent, a pure stream of CO₂ is then released by providing high energy to the sorbent, and followed by storage of CO₂ in geological reservoirs are common to both CCS and DAC. However, the release step is energy intensive which leads to high costs for both DAC and CCS. Therefore, a better scheme is needed that is much less energy intensive while still providing an effective solution for capture/removal of CO₂ along with permanent storage.

Chemical storage of CO₂ by chemical reaction with minerals (mineralization) is an attractive option. Mineralization can be performed by in-situ mineralization, ex-situ mineralization, or surface mineralization via enhanced weathering. Minerals for CO₂ mineralization include metal silicate minerals such as mafic and ultramafic rocks, basalt, peridotite, serpentine, olivine, plagioclase, pyroxene, ophiolite, wollastonite etc, wherein the metal atom includes calcium, magnesium or both. In these rocks involving calcium silicate and magnesium silicate, the reaction with CO₂ leads to the formation of corresponding metal carbonates and silica. Mineralization can also be done in metal silicates found in industrial alkaline wastes such as coal fly ash, cement kiln dust, slags produced in iron and steel making etc.

In-situ mineralization is an innovative carbon storage approach wherein CO₂ is injected into underground CO₂-reactive rocks, thereby converting CO₂ into stone. Ex-situ mineralization involves mining of rocks and their reaction with concentrated CO₂ in reactors under controlled conditions to produce environmentally benign carbonate minerals that can be safely disposed of, or used in industries such as construction. Surface mineralization via Enhanced weathering (EW) involves spreading finely ground CO₂-reactive rocks particles on large areas on land to increase the rate of weathering and facilitate carbon dioxide removal.

While chemical storage and mineralization methods offer promising solutions for long-term CO₂ storage, they face challenges related to kinetics and scalability. The rate of mineralization reactions can be slow, requiring large surface areas or high temperatures and pressures to accelerate the process. Additionally, the availability and accessibility of suitable mineral resources may limit the scalability of these methods, particularly for widespread deployment on a global scale.

To drive the cost of Carbon Capture and Carbon Removal technologies, simplified processes are needed with lower energy requirements and lesser number of steps. Further, large scale geological storage means are needed where chemical storage of CO₂ can be done in facile manner at low cost and large scale with least energy requirements. Therefore, other minerals need to be used for CO₂ mineralization which have a faster mineralization kinetics, lead to products that are commercially useful, scalable to gigatons storage, and provide a permanent yet environmentally friendly chemical storage of CO₂.

### BRIEF SUMMARY OF THE INVENTION

Trona, scientifically termed Sodium Sesquicarbonate hydrate with the chemical formula Na₂CO₃.NaHCO₃.2H₂O, is a water-soluble mineral and is world's largest known sodium carbonate resource. Embodiments disclosed herein relate to methods of geological CO₂ storage by in-situ mineralization in minerals comprising trona, and other minerals comprising sodium carbonate. Embodiments disclosed herein also relate to methods of carbon capture and storage, and Direct Air Capture (DAC) using minerals comprising trona, and other minerals comprising sodium carbonate. Embodiments disclosed herein also relate to simultaneous reactive absorption and mineralization of CO₂ using minerals comprising trona and other minerals comprising sodium carbonate.

Trona predominantly resides in Wyoming, USA, particularly within the Wilkins Peak Member of the Eocene Green River Formation in the Green River Basin. Besides trona, these beds often contain other sodium carbonate minerals like nahcolite and possibly wegscheiderite, all economically significant due to their solubility. Shortite, another abundant mineral in the Wilkins Peak Member, presents a potential source of soda ash, occurring in various forms within marlstone, oil shale, and mudstone beds alongside trona.

Trona is mined from underground mines in Wyoming as solid mineral via longwall mining, room and pillar mining and other methods. Trona is also mined via solution mining where the extracted trona brine comprises sodium carbonate, sodium bicarbonate, other soluble compounds, organic compounds and insoluble materials.

Embodiments described herein relate to a method of geological CO₂ storage by in-situ mineralization, the method comprising: injecting CO₂ and H₂O into a geological formation of a mineral comprising trona, wherein the injected H₂O dissolves a portion of the mineral comprising trona to form a solution comprising sodium carbonate, and wherein the CO₂ reacts with the sodium carbonate in solution to form sodium bicarbonate.

In some embodiments, CO₂ and H₂O are injected together as a mixture. In some embodiments, CO₂ and H₂O are injected in alternate cycles. In some embodiments, CO₂ and H₂O are injected using different pipes to avoid corrosion. In some embodiments, CO₂ and H₂O are injected using same pipe. In some embodiments, the at least one of CO₂ and H₂O are injected at an injection pressure in the range between about 0.1 MPa and about 1000 MPa. In some embodiments, wherein the at least one of CO₂ and H₂O are injected at an injection pressure in the range between about 0.5 MPa and about 10 MPa. In some embodiments, the sodium bicarbonate formed in-situ is extracted to the surface as a slurry or a suspension. In some embodiments, the sodium bicarbonate extracted to the surface is stored at a secondary location.

Embodiments described herein also relate to a method of geological CO₂ storage by in-situ mineralization, the method comprising: drilling a borewell into a trona bed, the trona bed comprising a deposit of trona; injecting a mixture of CO₂ and H₂O into the trona bed through the borewell, the H₂O dissolving the trona to form a mixture of sodium carbonate and sodium bicarbonate, and the CO₂ reacting with sodium carbonate in the dissolved trona to form sodium bicarbonate; and storing the sodium bicarbonate in-situ.

Embodiments described herein relate to a method of chemical storage of CO₂ via mineralization coupled with solution mining of trona, the method comprising: injecting a mixture of CO₂ and water through a system of wells connected through a bed of a mineral deposit comprising trona, wherein the injected water dissolves a portion of the mineral comprising trona to form a solution comprising sodium carbonate, and wherein the CO₂ in the mixture reacts with a portion of the solution comprising sodium carbonate to form a suspension comprising sodium bicarbonate; and extracting the suspension comprising sodium carbonate and sodium bicarbonate.

Embodiments described herein also relate to a method of geological CO₂ storage by in-situ mineralization, the method comprising: drilling a first borewell and a second borewell into a trona bed, the trona bed comprising a deposit of trona; connecting the first borewell and the second borewell through the trona bed to allow for flow of fluids from the first borewell to the second borewell; injecting a fluid comprising CO₂ and H₂O into the trona bed through the first borewell; flowing the fluid from the first borewell to a second borewell through the trona bed, the CO₂ in the fluid reacting with the trona to form sodium bicarbonate in-situ; and extracting the fluid comprising a portion of the sodium bicarbonate formed in-situ through the second borewell.

Embodiments described herein also relate to simultaneous capture of CO₂ from gas mixtures and its chemical storage in mineral trona or its components in solution. Embodiments described herein further relate to unique materials and formulations including trona solution to enhance the capture of CO₂ from gas mixtures. Embodiments described herein relate to capture of CO₂ thereby converting the mineral trona or its components in solution into sodium bicarbonate either in solution or as a precipitate. Embodiments described herein also relate to catalytic approaches for reactive absorption of CO₂ in trona solution thereby converting them into sodium bicarbonate either in solution or as a precipitate. Embodiments described herein also relate to catalytic approaches for reactive absorption of CO₂ from ambient air or other sources with low CO₂ concentration into trona solution to form a precipitate, the precipitate including at least one of sodium bicarbonate, sodium sesquicarbonate, or their combination.

Embodiments described herein also relate to a method of carbon capture and mineralization, the method comprising: solution mining a mineral comprising trona to form a trona solution, wherein the trona solution includes sodium carbonate dissolved in it; and reacting an input gas mixture comprising CO₂ with the trona solution in a reactor to form a suspension comprising a precipitate of sodium bicarbonate.

In some embodiments, a catalyst is added to the trona solution before reacting the input gas mixture comprising CO₂ with the trona solution. In some embodiments, the catalyst includes at least one of an amine, an amino acid, an amino acid salt, an ionic salt, an organic salt, an ionic liquid, a borate compound, an arsenate compound, a vanadium compound, a vanadate compound, a cuprous compound, a cupric compound, carbonic anhydrase, an organometallic compound, a surfactant, or combinations thereof.

In some embodiments, an additive is added to the trona solution before reacting the input gas mixture comprising CO₂ with the trona solution. In some embodiments, the additive includes an anionic surfactant added to enhance the precipitation of sodium bicarbonate. In some embodiments, the percentage of CO₂ in the input gas mixture is in the range between about 0.01% and about 90% by weight. In some embodiments, the input gas mixture comprising CO₂ is at least one of flue gas emission from a power plant, emission from an industrial process, or natural gas from a natural gas reservoir.

In some embodiments, the reactor includes at least one of a carbonation tower, an absorption tower, a scrubber, a cooling tower, a continuous stirred tank reactor, or another reactor suitable for reaction between a gas and a liquid. In some embodiments, the methods further comprise a filtration step to separate the precipitate of sodium bicarbonate from the suspension. In some embodiments, the sodium bicarbonate precipitate is stored in a surface reservoir, an underground reservoir, an underground cavern, an abandoned oil and gas well, an empty coal mine, an empty trona mine, or another underground formation.

Embodiments described herein further relate to a method of carbon capture and mineralization, the method comprising: dissolving a mineral comprising trona in water to form a trona solution, wherein the trona solution includes sodium carbonate dissolved in it; mixing the trona solution with a solution comprising a catalyst to form a solution mixture; and reacting ambient air comprising CO₂ with the solution mixture to form a precipitate, the precipitate including at least one of sodium carbonate, sodium sesquicarbonate, or their combination.

In some embodiments, the catalyst includes at least one of an amine, an amino acid, an amino acid salt, an ionic salt, an organic salt, an ionic liquid, a borate compound, an arsenate compound, a vanadium compound, a vanadate compound, a cuprous compound, a cupric compound, carbonic anhydrase, an organometallic compound, a surfactant, or combinations thereof. In some embodiments, the method further includes a filtration step to separate the precipitate from the trona solution. In some embodiments, the precipitate is stored in a surface reservoir, an underground reservoir, an underground cavern, an abandoned oil and gas well, an empty coal mine, an empty trona mine, or another underground formation.

In some aspects, the method of CO₂ mineralization comprises, mining of trona rock, crushing the trona rock into powdered form, reacting CO₂ with powdered trona rock in a reactor to convert at least a portion of sodium carbonate into sodium bicarbonate; storing the sodium bicarbonate so formed. In some aspects, the solution mined trona is mixed with a catalyst solution and directly exposed to ambient air to perform a Direct Air Capture of CO₂ to convert a portion of the sodium carbonate in the solution mined trona into sodium bicarbonate, wherein the sodium bicarbonate precipitates out of the solution and is filtered and stored.

Embodiments disclosed herein also relate to a carbon negative sodium bicarbonate produced by a chemical reaction between sodium carbonate from a trona solution and CO₂ from ambient air.

Embodiments disclosed herein also relate to a method of producing carbon negative sodium bicarbonate, the method comprising: dissolving a mineral comprising trona in water to form a trona solution, wherein the trona solution includes sodium carbonate dissolved in it; mixing the trona solution with a solution comprising a catalyst to form a solution mixture; and reacting ambient air comprising CO₂ with the solution mixture to form a precipitate of sodium bicarbonate. In some embodiments, the catalyst includes at least one of an amine, an amino acid, an amino acid salt, an ionic salt, an organic salt, an ionic liquid, a borate compound, an arsenate compound, a vanadium compound, a vanadate compound, a cuprous compound, a cupric compound, carbonic anhydrase, an organometallic compound, a surfactant, or combinations thereof.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a method of CO₂ storage via in-situ mineralization in a trona bed, according to an embodiment.

FIG. 2 shows another method of CO₂ storage via in-situ mineralization in a trona bed, according to an embodiment.

FIG. 3 shows another method of CO₂ storage via in-situ mineralization in a trona bed, according to an embodiment.

FIG. 4 shows another method of CO₂ storage via in-situ mineralization in a trona bed, according to an embodiment.

FIG. 5A shows a method of reactive absorption and mineralization of CO₂ from an input gas mixture into a solution comprising trona, according to an embodiment.

FIG. 5B shows a process flow diagram of a process for reactive absorption and mineralization of CO₂ from an input gas mixture into a solution comprising trona, according to an embodiment.

FIG. 6A shows a method of CO₂ capture and storage, the method comprising spraying a solution of a mineral comprising trona to enhance the reactive absorption of CO₂, according to an embodiment.

FIG. 6B shows a schematic of an individual droplet of the sprayed solution of a mineral comprising trona as used in the method shown in FIG. 6A, according to an embodiment.

FIG. 7 shows a process flow of a method of CO₂ capture and storage in mined trona, according to an embodiment.

FIG. 8 shows a method of Direct Air Capture and mineralization of CO₂ in a solution of a mineral comprising trona, according to an embodiment.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Trona, scientifically termed Sodium Sesquicarbonate hydrate with the chemical formula Na₂CO₃.NaHCO₃.2H₂O, is a water-soluble mineral and is world's largest known sodium carbonate resource. Embodiments disclosed herein relate to methods of geological CO₂ storage by in-situ mineralization in minerals comprising trona, and other minerals comprising sodium carbonate. Embodiments disclosed herein also relate to methods of carbon capture and storage, and Direct Air Capture (DAC) using minerals comprising trona, and other minerals comprising sodium carbonate. Embodiments disclosed herein also relate to simultaneous reactive absorption and mineralization of CO₂ in minerals comprising trona or other minerals comprising sodium carbonate.

Embodiments described herein relate to a method of CO₂ mineralization, the method comprising injecting a mixture comprising CO₂ in a trona mineral geological formation, wherein the CO₂ reacts with the sodium carbonate in the trona rock to form sodium bicarbonate. In some aspects, the method is of CO₂ mineralization comprises, mining of trona rock via solution mining, reacting CO₂ with a solution of trona in a reactor to convert at least a portion of sodium carbonate into sodium bicarbonate. Embodiments described herein further relate to capture of carbon dioxide directly from air and storing it into solution mined trona as sodium bicarbonate.

In some embodiments, the trona deposits contains only trona (sodium sesquicarbonate phase). In some embodiments, the trona deposit is reactive to CO₂. In some embodiments, the trona is reactive to CO₂ in the presence of moisture/water vapor/water/steam. In some embodiments, the trona is reactive to CO₂ at high temperature and pressure. In some embodiments, trona is reactive to CO₂ in an aqueous solution. In some embodiments, trona dissociates into sodium carbonate and sodium bicarbonate upon dissolution in solution, the sodium carbonate in solution reacting with CO₂ to form sodium bicarbonate.

In some embodiments, trona may be reactive to CO₂ at high temperature and pressure. In some embodiments, trona is made to be reactive to CO₂ by raising the temperature above the decomposition temperature of trona. In some embodiments, trona in an aqueous solution is reactive to CO₂ in a wide range or temperatures and pressures.

In some embodiments, trona in solid state or in solution is reactive to CO₂ in a temperature range between about 20° C. and about 150° C. In some embodiments, trona in solid state or in solution is reactive to CO₂ in a temperature range between about 20° C. and about 50° C. In some embodiments, trona in solid state or in solution is reactive to CO₂ in a temperature range between about 50° C. and about 80° C. In some embodiments, trona in solid state or in solution is reactive to CO₂ in a temperature range between about 80° C. and about 150° C. In some embodiments, trona in solid state or in solution is reactive to CO₂ at a temperature above about 50° C. In some embodiments, trona in solid state or in solution is reactive to CO₂ at a temperature above about 100° C. In some embodiments, trona in solid state or in solution is reactive to CO₂ at a temperature above about 150° C.

In some embodiments, the trona in solid state or in solution is reactive to CO₂ at a pressure in the range between about 0.01 MPa and about 1000 MPa. In some embodiments, the trona in solid state or in solution is reactive to CO₂ at a pressure in the range between about 0.01 MPa and about 0.1 MPa. In some embodiments, the trona in solid state or in solution is reactive to CO₂ at a pressure in the range between about 0.1 MPa and about 1 MPa. In some embodiments, the trona in solid state or in solution is reactive to CO₂ at a pressure in the range between about 1 MPa and about 10 MPa. In some embodiments, the trona in solid state or in solution is reactive to CO₂ at a pressure in the range between about 10 MPa and about 100 MPa. In some embodiments, the trona in solid state or in solution is reactive to CO₂ at a pressure above 1 MPa. In some embodiments, the trona in solid state or in solution is reactive to CO₂ at a pressure above 10 MPa. In some embodiments, the trona in solid state or in solution is reactive to CO₂ at a pressure above 100 MPa.

In some embodiments, the trona bed contains other minerals as impurities. In some embodiments, the total amount of impurities in the bed is between 0.1% and 95% by weight. In some embodiments, the impurities in the trona bed are water soluble. In some embodiments, the impurities in the trona are water insoluble. In some embodiments, the impurities in the trona are reactive towards CO₂. In some embodiments, the impurities in the trona are reactive towards HCl. In some embodiments, the impurities in the trona are reactive towards NOx. In some embodiments, the impurities in the trona are reactive towards SO₂ and/or SO₃.

In some embodiments, the injection fluid injected into the trona bed comprises supercritical CO₂. In some embodiments, the supercritical CO₂ in the reacts with the sodium sesquicarbonate in the trona to form sodium bicarbonate. In some embodiments, the injected CO₂ remains stored in trona bed in physical form without any chemical reaction.

In some embodiments, the CO₂ in the injected fluid directly reacts with the trona bed to form sodium bicarbonate. In some embodiments, temperature of the injected fluid is high enough to melt the hydrated sodium sesquicarbonate in trona. This allows for the formation of carbonate ions and H⁺ ions (from the water in the molecule as well as in the injected fluid) which react with CO₂ in the injected fluid to form sodium bicarbonate. In some embodiments, the high pressure of the injected fluid favors the reaction of CO₂ with the trona to form sodium bicarbonate.

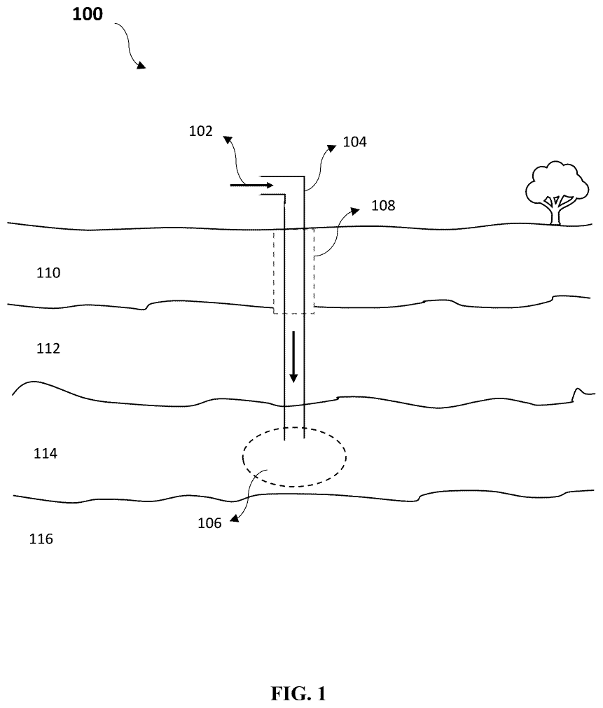

FIG. 1 shows a schematic representation of a method 100 of CO₂ sequestration in the bed of a mineral comprising trona which is shown in the figure as 114, and hereinafter referred to as trona bed. In some embodiments, the trona bed 114 is sandwiched between two beds of oil shales at the top and the bottom shown in the figure as 112 and 116 respectively. A borewell is drilled through the subsurface layers to reach the trona bed 114 and lined with pipes to form a borewell 104. In some embodiments, the borewell 104 is a permanent borewell. The borewell 104 is lined with concrete support 108 to secure it in place. During operation, an injection fluid 102 is injected into the borewell 104 to reach trona bed 114 where it first dissolves trona to form a solution zone 106 and further reacts with it to form sodium bicarbonate.

In some embodiments the composition of injected fluid 102 into trona could be may be a mixture of CO₂ and water wherein the CO₂ content can be between 1% and 99%. In some embodiments, the injection fluid 102 may be pure CO₂. In some embodiments, the injection fluid 102 may be a mixture of CO₂ with water and other gases such as oxygen, nitrogen, Argon, H₂, NO, NO₂, H₂S, SO₂, or SO₃ in varying proportions. In some embodiments, the injection fluid 102 may be a flue gas mixture from an industrial facility, a coal power plant, or a natural gas power plant. In some embodiments, the injection fluid 102 may be a mixture of CO₂ with another gas. In some embodiments, the injection fluid 102 may be a compressed mixture of a reactive gas with CO₂, for example, a mixture of HCl with CO₂, a mixture of NOx with CO₂, a mixture of SOx with CO₂. In some embodiments, the injection fluid may be compressed air with a CO₂ percentage in the range between about 0.02% and about 30%. In some embodiments, the injection fluid 102 may be a natural gas from a geological formation comprising CO₂ in the range between about 0.1% and about 80%.

In some embodiments, the injected fluid may include gases that are non-reactive to trona. In some embodiments, a portion of the injected fluid comprising gases non-reactive to trona are extracted out as an exhaust. In some embodiments, the injected fluid is held in the trona bed for a predetermined period of time to allow for reactions to occur, before extracting the non-reactive gases from the trona bed. In some embodiments, the injection and extraction cycles are performed alternately.

In some embodiments the phase of injection fluid 102 can be liquid or gas. In some embodiments, the water in the injection fluid 102 can be in the form of steam, or hot water. In some embodiments, the temperature of water can be between 20° C. and about 100° C. In some embodiments, the steam can be at a temperature between 100° C. and about 500° C. In some embodiments, the CO₂ in the injection fluid 102 is in the supercritical state. In some embodiments, the injection fluid 102 comprising a mixture of H₂O and CO₂ is in supercritical state. In some embodiments, the injection fluid 102 in supercritical state is at a temperature between 5° C. and about 500° C.

In some embodiments the pressure of the injection fluid 102 is between 0.1 MPa and 1000 MPa. In some embodiments the pressure of the injection fluid is between 0.1 MPa and 1 MPa. In some embodiments the pressure of the injection fluid is between 1 MPa and 10 MPa. In some embodiments, the pressure of the injection fluid is between about 10 MPa and about 100 MPa. In some embodiments, the pressure of the injection fluid is in the range between about 100 MPa and about 1000 MPa.

In some embodiments, the injection fluid 102 comprises a mixture of CO₂ and H₂O. In some embodiments, the percentage of H₂O in the injection fluid 102 is in the range between about 1% and about 99%. In some embodiments, the water in the injection fluid 102 is in the liquid phase. In some embodiments, the water in the injected fluid mixture is in vapor/gaseous phase, for example as steam. In some embodiments the CO₂ in the injected fluid mixture is in liquid state. In some embodiments the CO₂ in the injection fluid is in gaseous state.

In some embodiments, the temperature of the injection fluid 102 is in the range between about 1° C. and about 500° C. In some embodiments, the temperature of the injection fluid 102 is in the range between about 1° C. and about 50° C. In some embodiments, the temperature of the injection fluid 102 is in the range between about 50° C. and about 100° C. In some embodiments, the temperature of the injection fluid 102 is in the range between about 100° C. and about 200° C. In some embodiments, the temperature of the injection fluid 102 is in the range between about 200° C. and about 500° C.

In some embodiments, the water in the injection fluid 102 dissolves the trona in the bed 114 to form a solution zone 106, the solution zone comprising a solution of sodium carbonate and sodium bicarbonate. The solubility of sodium bicarbonate in water is much less than that of sodium carbonate. Therefore, the solution of trona dissolved in injection fluid 102 includes a larger percentage of sodium carbonate in solution compared to sodium bicarbonate.

The CO₂ in the injection fluid 102 reacts with the sodium carbonate in the solution in the solution zone 106 to form sodium bicarbonate in-situ. In some embodiments, the sodium bicarbonate formed in-situ precipitates out of the solution. Thus, both sodium carbonate and sodium bicarbonate are removed from the solution due to the reaction with CO₂ in the injection fluid 102.

The consumption of sodium carbonate in the solution by reacting with CO₂ to form sodium bicarbonate and its subsequent precipitation lowers the amount of solute in solution which allows for further dissolution of trona in the solution. The reaction of one mole each of sodium carbonate with CO₂ uses one mole of water to form two moles of sodium carbonate. Since each mole of trona has two moles of water of hydration, the dissolution of trona to form the solution zone 106 leads to release of extra water in the solution which may further aid the dissolution of trona. Therefore, due to combination of these two effects, as more of the CO₂ in the injection fluid enters the trona bed, the requirement of water in the injection fluid 102 to perpetuate the reaction keeps decreasing.

In some embodiments, percentage of water in the injection fluid 102 is maintained at the same level with time as more injection fluid 102 is injected in the trona bed 114. In some embodiments, the proportion of water in the injection fluid 102 is reduced with time as more injection fluid is injected into the trona bed 114. As the reaction between CO₂, H₂O and trona solution continues, more trona dissolves in water and the solution zone expands. Since the thickness of trona bed is typically in the range between about 3 m and about 10 m, after a certain time, the solution zone starts laterally after the initial phase of uniform expansion in all dimensions.

There is additional mass added to the trona bed locally due to injection of the injection fluid 102, formation of solution zone 106 and reaction of CO₂ in the injection fluid with trona solution to form sodium bicarbonate in-situ. As a result, there is volume expansion and a pressure buildup in the trona bed. In some embodiments, the precipitated sodium bicarbonate formed after reaction with injection fluid is periodically removed. This allows for reduction in build up pressure in the trona bed due volume expansion. In some embodiments the sodium bicarbonate formed in-situ is removed from the trona bed 114 as a slurry. In some embodiments the sodium bicarbonate formed in-situ is removed from the trona bed 114 along with the trona solution in the solution zone as a suspension. This removal of sodium bicarbonate allows for injection of greater volume for injection fluid in the trona bed and therefore a greater size/volume of the solution zone.

In some embodiments the removed sodium bicarbonate is stored at a secondary location. In some embodiments the removed sodium bicarbonate is stored on the earth surface in a natural lake/pond or in an artificially created surface reservoir. In some embodiments the removed sodium bicarbonate is stored in an underground reservoir, underground cavern, an abandoned oil and gas well, an empty mine such as a coal mine or an empty trona mine, or another underground formation.

In order to start the CO₂ sequestration operations, first a solution zone is created in at the bottom of the drilled borewell. Water is first injected through the borewell to dissolve the trona bed locally at the bottom of the well and held for a predetermined amount of time to allow for the dissolution to complete. The trona solution so formed is pumped out above ground. In some embodiments, the water temperature is in the range between about 20° C. and about 80° C. This is done for a sufficient time and cycles to create a desired size solution zone before CO₂ sequestration begins. During the initial CO₂ sequestration phase, the injected fluid comprises a greater percentage of water compared to CO₂. In some embodiments, during the initial phase, the injected fluid comprises water in the range between about 80% and about 100% by weight.

Once a desired size solution zone 106 is formed, a mixture of CO₂ and H₂O can be injected into the solution zone 106. In some embodiments, only CO₂ in injected into the solution zone. In some embodiments a gas mixture comprising CO₂ may be injected. In some embodiments, H₂O and CO₂ may be injected separately in alternate cycles. In some embodiments, H₂O is injected once every few cycles of CO₂ injection. In some embodiments, the borewell may have separate pipes for injection of CO₂ and H₂O. These schemes allow for control over the reaction in the solution zone. Since the mixture of CO₂ and H₂O is acidic, injection of CO₂ and H₂O in different cycles or with different pipes allows for prevention of corrosion of the pipes or tubes in the borewell.

The reaction between sodium carbonate and CO₂ to form sodium bicarbonate is exothermic and therefore may lead to increase in the temperature of the solution zone. In some embodiments, the temperature of the solution is monitored constantly or intermittently. In some embodiments, the rate of CO₂ injection is controlled to prevent thermal run-off in the solution zone which may have deleterious effect on the borewell.

In some embodiments, the temperature of the water injected in the solution zone is less than 20° C. to cool off the solution zone. In some embodiments, the injection of CO₂ in the solution zone is suspended to allow for the solution zone 106 to cool down once a threshold temperature is reached. In some embodiments, the trona solution in solution zone 106 is extracted out once a threshold temperature is reached. In some embodiments, threshold temperature is in the range between about 50° C. and about 200° C.

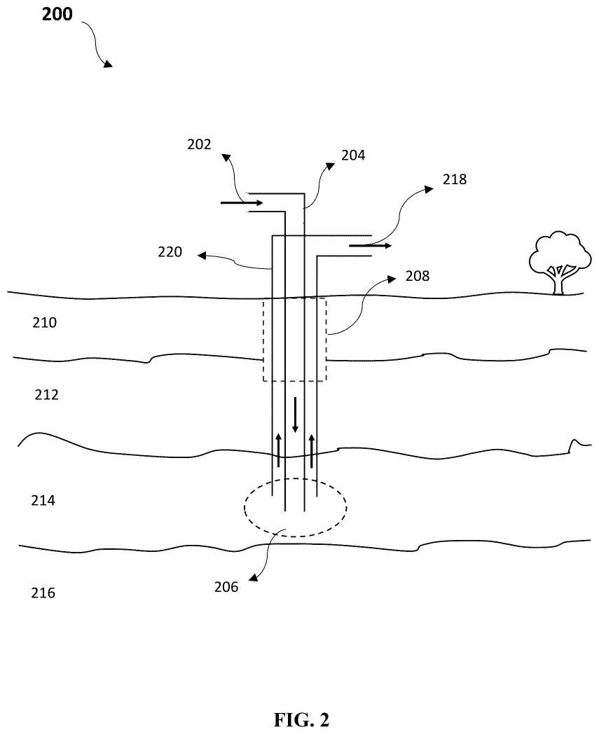

FIG. 2 shows another method 200 of CO₂ storage in trona where a portion of the injected fluid is extracted out using another concentric pipe in the same borewell. As shown, the injected fluid 202 is injected into the trona bed via pipe 204 leading to a formation of a solution zone 206. The composition, phase, pressure, temperature of the injected fluid 202 is same as that described for injected fluid 102 including all the variations.

The CO₂ in the injected fluid 202 reacts with the sodium carbonate in the trona solution in solution zone 206 to form sodium bicarbonate. In some embodiments the sodium bicarbonate so formed precipitates out of the solution. As shown in the FIG. 2, a portion of the fluid from the solution zone is extracted out to accommodate volume changes associated with the fluid injection and the reaction of CO₂ with the production of sodium bicarbonate in-situ. In some embodiments, the extracted fluid or slurry 218 is stored at a secondary location. In some embodiments, the extracted fluid or slurry 218 is stored on the earth surface in a natural lake/pond or in an artificially created surface reservoir. In some embodiments, the extracted fluid or slurry 218 is stored in an underground reservoir, underground cavern, an empty oil and gas well, an empty mine such as a coal mine or an empty trona mine or another underground formation.

In some embodiments the injected fluid 202 flows in the annular pipe 220 and the extracted fluid or slurry 218 flows in the inner pipe 204. In some embodiments, the characteristics of the solution zone 206 is same as that described for solution zone 106 including all the variations.

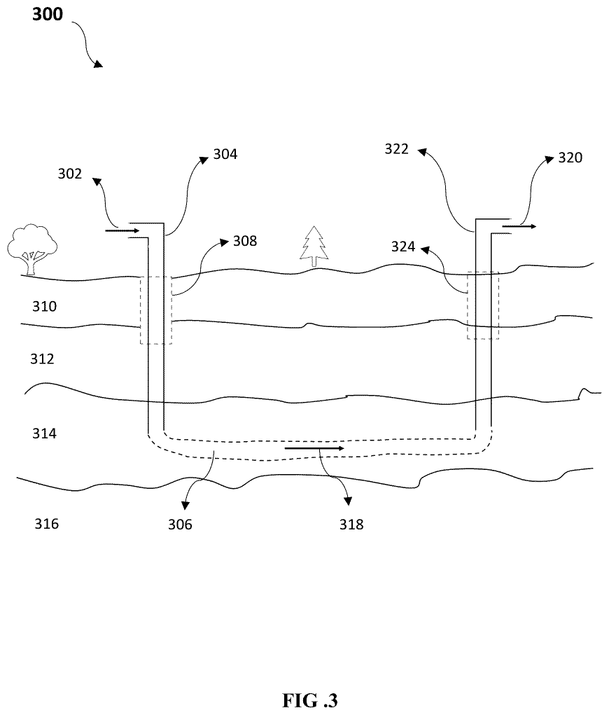

FIG. 3 shows an alternative method 300 of CO₂ storage in trona. The method combines solution mining technique with the CO₂ sequestration via reactive absorption of CO₂ in the trona solution via in-situ mineralization. The method comprises: injecting a mixture of CO₂ and water through a system of wells connected through a bed of a mineral deposit comprising trona, the system of wells including at least one well for injection of fluids and at least one well for extraction of fluids, wherein the water in the injected mixture dissolves a portion of the mineral comprising trona to form a solution comprising sodium carbonate, and wherein the CO₂ in the injected mixture reacts with a portion of the solution comprising sodium carbonate to form a suspension comprising sodium bicarbonate; and extracting the suspension comprising sodium carbonate and sodium bicarbonate.

As shown in the FIG. 3, an injection fluid 302 comprising a mixture of water and CO₂ is injected into the trona bed via an input borewell 304. The input borewell 304 is secured by a concrete structure 308 around it. As shown, this method comprises solution mining through the use of two borewells 304 and 322 used respectively for injection of injected fluid 302 and extraction of the extracted fluid (slurry or suspension) 320. The borewells 304 and 322 are secured in placed using concrete structures 308 and 324. A solution zone 306 comprises a continuous fluid flow pathway through the trona bed 314 between borewells 304 and 322.

In some embodiments, the separation between borewell 304 and the borewell 322, which is also representative length of the solution zone 306, is between about 1 m and about 1000 m. In some embodiments, the separation between borewell 304 and the borewell 322 is between about 10 m and about 100 m. In some embodiments, the separation between borewell 304 and the borewell 322 is between about 10 m and about 100 m. In some embodiments, the separation between borewell 304 and the borewell 322 is between about 100 m and about 500 m. In some embodiments, the separation between borewell 304 and the borewell 322 is between about 500 m and about 1000 m.

In some embodiments, the injection fluid 302 has the similar composition, phase, pressure and temperature as well as the variations described in the previous section for injection fluid 102 and 202. In some embodiments, the water in the injected fluid dissolves a portion of the trona bed 314 to form sodium carbonate and sodium bicarbonate ions in solution. In some embodiments the solution so formed in the solution zone 306 comprises a saturated solution of sodium carbonate and sodium bicarbonate along with the impurities such as halite which are present in the trona bed. In some embodiments, the sodium bicarbonate precipitates out of solution due to its lower solubility.

The CO₂ in the injected fluid reacts with the sodium carbonate and water in solution to form sodium bicarbonate which precipitates out of the solution due to its lower solubility thus allowing for further dissolution of another portion of the trona bed in the trona solution 318 as it moves through the solution zone 306 towards the borewell 322. In some embodiments, the precipitated sodium bicarbonate settles at the bottom of the solution zone 306. In some embodiments, the precipitated sodium bicarbonate remains suspended in the solution 318 and it moves through the solution zone 306 toward the borewell 322.

In some embodiments, the percentage of water in the injected fluid 302 is progressively decreased with time as more of the sodium carbonate precipitates out of solution following the reaction of CO₂ in the injected fluid with sodium carbonate thus making more water in the solution zone 306 available for further dissolution of the trona bed 314. In some embodiments, the percentage of water in the injected fluid is maintained at a higher level initially and then later reduced to a constant lower level with the passage of time.

In some embodiments, the extracted fluid or slurry 320 is devoid of any molecular CO₂. In other words, the entire portion of CO₂ in the injection fluid 302 undergoes reactive absorption in trona solution to form sodium bicarbonate. In some embodiments, the extracted fluid or slurry 320 comprises a mixture of water and sodium bicarbonate. In some embodiments, the extracted fluid or slurry 320 is comprises sodium carbonate, sodium bicarbonate and water. In some embodiments, the extracted fluid or slurry 320 comprises halite impurities.

While not explicitly shown, a plurality of borewells can be used to extract fluid or slurry. In some embodiments, a plurality of borewells is placed radially away from the input borewell 304. In some embodiments, different borewells can extract the fluid or slurry 320 at different rate.

In some embodiments, the injection fluid 302 comprises a mixture of CO₂, H₂O, O₂ and N₂. In some embodiments, the injection fluid 302 comprises the flue gas mixture from a coal power plant, a natural gas power plant or another industrial facility. In some embodiments, the injection fluid 302 is natural gas mixture from natural gas reservoir comprising CO₂. In some embodiments, the percentage of CO₂ in the natural gas mixture in in the range between about 0.1% and about 80%.

In some embodiments, a portion of the CO₂ in the injection fluid 302 is stored in the trona bed physically. In some embodiments, a portion of the CO₂ in the injected fluid is stored physically in the oil shales beds and other beds adjacent to the trona bed.

In some embodiments, the extracted fluid or slurry 320 is stored at a secondary location. In some embodiments, the extracted fluid or slurry 320 is stored on the earth surface in a natural lake/pond or in an artificially created surface reservoir. In some embodiments, the extracted fluid or slurry 320 is stored in an underground reservoir, underground cavern, an empty oil, an empty natural gas well, an empty mine such as a coal mine or an empty trona mine or another underground formation.

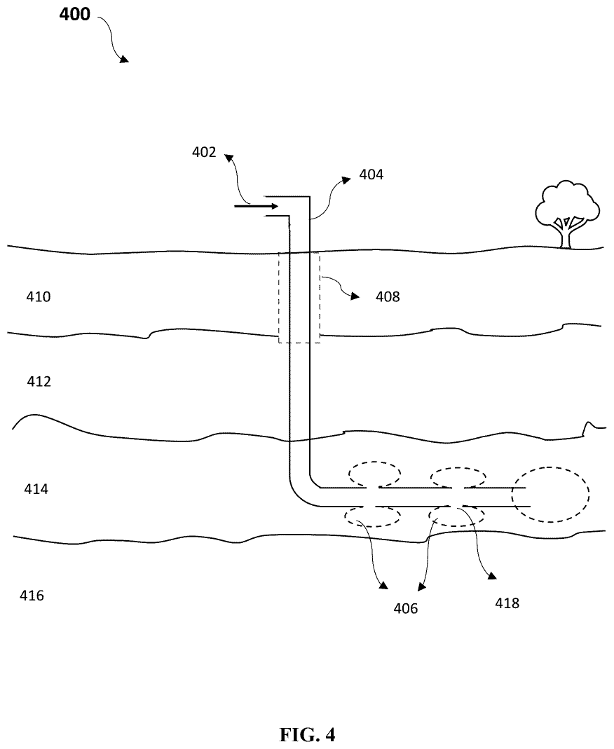

FIG. 4 shows an alternative method 400 of in-situ mineralization of CO₂ in the trona bed. The method involves a borewell 404 with a portion of the borewell being horizontally drilled into the trona bed 414. The injection fluid 402 is pumped into the trona bed 414 via a borewell 404. The borewell 404 comprising a casing and a pipe is secured in place via a concrete structure 408. The borewell 404 after reaching the trona bed changes its trajectory from vertical to horizontal. A plurality of openings 418 are made in the horizontal section of the borewell which may be opened through various means at different time intervals during the operation of the borewell. The injected fluid 402 dissolves the trona forming a plurality of solution zones 406. The CO₂ in the injected fluid reacts with the trona solution to form sodium bicarbonate which precipitates out of solution to be stored within the bed. In this horizonal drilling method, the plurality of openings provides options to create large volume of solutions to be formed such that a correspondingly larger amount of CO₂ to be sequestered in the trona bed via the same borewell.

The composition, temperature, pressure and phase of the injected fluid 402 is similar to the that described in previous sections for injected fluid 102 along with its variations. The composition and process of CO₂ sequestration in solution zone 406 in trona bed 414 is similar to that described in previous sections for the solution zone 106 in the trona bed 114 along with the described variations.

In some embodiments, the furthest opening of the borewell is opened first, leading to the creation of solution zone locally around the furthest opening. The CO₂ in the injected fluid reacts with the trona solution in this zone forming sodium bicarbonate in-situ. Once a major portion of the trona bed around this opening is converted to sodium bicarbonate, another opening having solid trona bed around it is opened via an explosive charge or another means and the process is repeated.

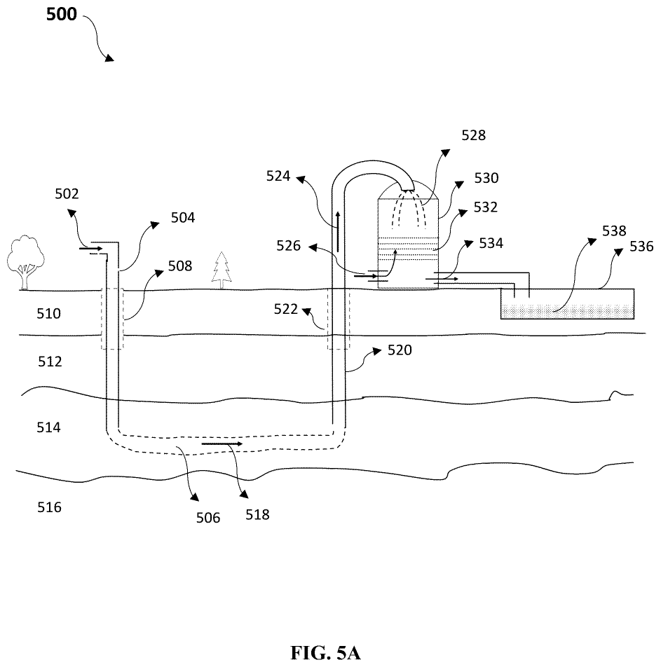

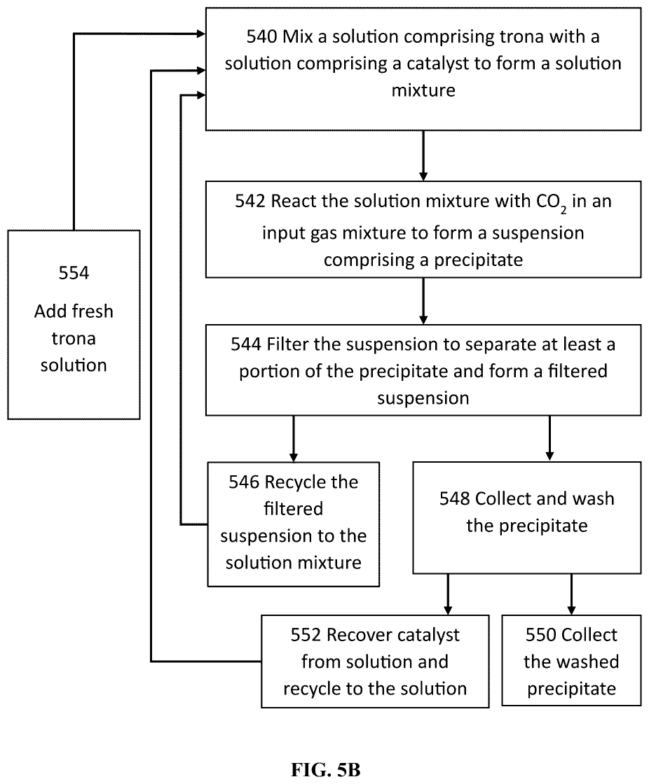

FIG. 5A shows a method 500 for CO₂ capture and mineralization in solution mined trona. This method combines solution mining of trona with reactive absorption of an CO₂ from an input gas mixture in a reactor to produce sodium bicarbonate which is filtered and stored or utilized. As shown in the FIG. 5, the solution mining of trona comprises an injection borewell 504 used for injecting an injection fluid 502 into the trona bed 514, the fluid traveling through the solution zone 506 forming a trona solution 518 comprising sodium carbonate, sodium bicarbonate and undissolved solids, the trona solution being extracted from the extraction borewell 520 as the extraction fluid 524 as suspension or slurry. The borewells 504 and 520 are secured in place by concrete structures 508 and 522. The trona bed has beds 512 and 516 on its either side comprising oil shales or other minerals.

In some embodiments, the injection fluid 502 is substantially similar in composition, phase, pressure and temperature as the injection fluid 102, 202, 302 described in previous sections along with the described variations. In some embodiments, the injection fluid 502 comprises water only. In some embodiments, the injection fluid 502 comprises a mixture of CO₂ with H₂O. In some embodiments, the injection fluid 502 does not include any CO₂. The flow of injection fluid 502 through the solution zone 506 leads to dissolution of trona to form a trona solution 518.

In some embodiments, the injection fluid 502 comprises a mixture of H₂O and an organic solvent. In some embodiments the solvent is at least one of glycerol, ethylene glycol, propylene glycol, propylene carbonate, ethanol, methanol, isopropanol, or combinations thereof. In some embodiments, the organic solvent is chosen to selectively dissolve sodium carbonate and leave behind sodium bicarbonate. In such a situation the water in the injection fluid 502 dissolves the trona thus forming a solution comprising sodium ions, carbonate ions and bicarbonate ions in solution. The presence of a solvent in the injection fluid 502 having selective solubility for sodium carbonate ensures that a larger percentage of sodium carbonate and a much smaller percentage of sodium bicarbonate is dissolved in the solution.

In some embodiments, when the injection fluid 502 comprises both CO₂ and H₂O, the CO₂ reacts with the sodium carbonate in the trona solution 518 to form sodium bicarbonate which precipitates out of solution thus allowing the water in the injection fluid to dissolve additional amount of trona. In some embodiments, a portion of the precipitated sodium bicarbonate settles at the bottom of the solution zone. In some embodiments, a portion of the precipitated sodium bicarbonate remains suspended in the trona solution 518. In some embodiments, the extraction fluid 524 comprises sodium carbonate, sodium bicarbonate and water. In some embodiments, the extraction fluid 524 does not include any CO₂ in it. In some embodiments, the extraction fluid 524 is a suspension or a slurry comprising sodium bicarbonate particles and/or other insoluble solids.

While not explicitly shown, the extraction fluid 524 may undergo a filtration step to remove at least a portion of insoluble impurities. In some embodiments, the filtration step is skipped. In some embodiments, the filtered or unfiltered extraction fluid 524 is mixed with a solution comprising a catalyst to form a solution mixture 528. The solution mixture 528 is then sprayed through a reactor 530 where it reactively absorbs CO₂ from an input gas mixture 526. The catalyst enhances the rate of reactive absorption of CO₂ from the input gas mixture 526 into the sodium carbonate present in the solution mixture 528.

The catalyst can be at least one of an amine, an amino acid, an amino acid salt, an ionic salt, an organic salt, an ionic liquid, a borate compound, an arsenate compound, a vanadium compound, a vanadate compound, a cuprous compound, a cupric compound, carbonic anhydrase, an organometallic compound, a surfactant, or combinations thereof. In some embodiments, the catalyst is a solid material. In some embodiments the catalyst is a polymer. In some embodiments, the catalyst is an organic compound comprising a heterocyclic ring that includes at least one nitrogen atom.

In some embodiments, the amine as a catalyst may include primary, secondary, and tertiary alkylamines and alkanolamines, aromatic amines, mixed amines, polyamines, and combinations thereof. In some embodiments the catalyst is an amine selected from a list comprising at monoethanolamine (MEA), diethanolamine (DEA), diethylenetriamine (DETA), ethylenediamine, piperidine, piperazine, 2-(2-aminipethylamino) ethanol, diisopropanolamine, 2-amino-2-methyl-1,3-propanediol, pentaethylenehexamine, tetramethylenepentaamine, tetraethylenepentamine (EPA), mehyldiethanolamine (MDEA), polyallylamines, aminosilanes, tetraalkoxysilanes, animoalkylalkoxysilanes, and polymeric amines (e.g. polyethyleneimines (PEI), etc.), as well as combinations and mixtures including one or more of the foregoing, but the disclosure is no limited thereto.

In some embodiments, the catalyst is an amino acid selected from a group comprising alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine. In some embodiments, the catalyst is an amino acid salt, the anion of which is selected from a group comprising alaninate, arginate, asparaginate, aspartate, cysteinate, glutaminate, glutamate, glycinate, histidinate, isoleucinate, leucinate, lysinate, methionate, phenylalanineate, prolinate, serinate, threoninate, tryptophanate, tyrosinate, valinate. In some embodiments, the catalyst is an amino acid salt, the cation of which is selected from a group comprising Na⁺, K⁺, Li⁺, Ca²⁺, Mg²⁺, or other common metal cations.

In some embodiments, where the catalyst is an ionic salt, at least one of the cations or the anion is organic. In some embodiments where the catalyst is an ionic salt, the cation is selected from a list comprising sodium, potassium, lithium, calcium, magnesium, iron, copper, nickel, cobalt, silver, and tin. In some embodiments where the catalyst is an ionic salt, the anion is selected from a list comprising fluoride (F⁻), chloride (Cl⁻), bromide (Br), iodide, nitrite (NO₂⁻), nitrate (NO₃⁻), sulfate, i.e., sulphate (SO4²⁻), sulfite, borate, arsenate, and phosphate (PO₄³⁻).

In some embodiments the catalyst is a liquid miscible with water. In some embodiments the catalyst is a liquid immiscible with water. In some embodiments, the catalyst is a solid soluble in water. In some embodiments the catalyst is a solid present as particles in the solution. In some embodiments, the catalyst is mixed in the solution and forms a colloidal solution.

In some embodiments, where the catalyst is an ionic liquid or an ionic salt, the cation is selected from a list comprising ammonium, imidazolium, phospohonium, pyridinium, pyrrolidinium, and sulfonium ions. In some embodiments where the catalyst is an ionic liquid or an ionic salt, the anion is a selected from a list comprising alkylsulfate, tosylate, methanesulfonate, bis(trifluoromethylsulfonyl)imide, hexafluorophosphate, tetrafluoroborate, or halide.

In some embodiments, the ionic liquid catalyst is selected from a group comprising 1-ethyl-3-methylimidazolium bis(trifluoromethylsulfonyl)imide, 1-butyl-3-methylimidazolium bis(trifluoromethylsulfonyl)imide, 1-ethyl-2,3-dimethylimidazolium bis(trifluoromethylsulfonyl)imide, 1-butyl-3-methylimidazolium trifluoromethanesulfonate, 1-butyl-2,3-methylimidazolium bis(trifluoromethylsulfonyl)imide, and 1-methyl acetyl, 3-methylimidazolium bis(trifluoromethylsulfonyl)imide. The ionic liquid catalyst in specific embodiments may include a substituted imidazolium group and a bis(trifluoromethylsulfonyl)imide group.

The ionic liquid may be present in any suitable concentration in the sorbent, which is effective to enhance the absorption of CO₂. In some embodiments, the concentration of ionic liquid catalyst is in the range between about 1 ppm and about 10000 ppm by weight. In some embodiments, the concentration of ionic liquid catalyst is in the range between about 1 ppm and about 100 ppm by weight. In some embodiments, the concentration of ionic liquid catalyst is in the range between about 100 ppm and about 1000 ppm by weight. In some embodiments, the concentration of ionic liquid catalyst is in the range between about 1000 ppm and about 5000 ppm by weight. In some embodiments, the concentration of ionic liquid catalyst is in the range between about 5000 ppm and about 1000 ppm by weight.

In some embodiments, the trona solution 524 may further include at least one of borate ions, arsenate ions, vanadate ions, or their combination incorporated by dissolution of naturally occurring minerals in the trona bed 514. These ions present in 524 may catalyze the simultaneous reactive absorption and mineralization of CO₂ form the input gas mixture into the trona solution to form sodium bicarbonate precipitate.

In some embodiments, the amount of catalyst in solution mixture is in the range between about 0.1% and about 70% by weight. In some embodiments, the amount of catalyst in the solution mixture is in the range between about 0.1% and about 1% by weight. In some embodiments, the amount of catalyst in the solution mixture is in the range between about 1% and about 5% by weight. In some embodiments, the amount catalyst in the solution mixture is in the range between about 5% and about 10% by weight. In some embodiments, the amount of catalyst in the solution mixture is in the range between about 10% and about 20% by weight. In some embodiments, the amount of catalyst in the solution mixture is in the range between about 20% and about 40% by weight. In some embodiments, the amount of catalyst in the solution mixture is in the range between about 40% and about 70% by weight.

In some embodiments, the amount of catalyst in the solution mixture is at least 1% by weight. In some embodiments, the amount of catalyst in the solution mixture is at least 5% by weight. In some embodiments, the amount of catalyst in the solution mixture 102 is at least 10% by weight. In some embodiments, the amount of catalyst in the solution mixture is at least 20% by weight. In some embodiments, the amount of catalyst in the solution mixture is at least 30% by weight. In some embodiments, the amount catalyst in the solution mixture is at least 40% by weight.

While not explicitly shown in FIG. 5A, the solution mixture 528 may further comprise an additive. In some embodiments, the additive comprises a least one of a surfactant, a precipitation agent, a retardation agent, a chelating agent, a catalytic promoter, or combinations thereof. The purpose of the precipitation agent is to facilitate the precipitation of sodium bicarbonate from solution. The purpose of retardation agent is to prevent the precipitation of chemical compounds other than the sodium bicarbonate. The retardation agent prevents the precipitation of at least one of catalyst, sodium carbonate decahydrate, sodium sesquicarbonate, or another chemical compound other than sodium bicarbonate. The chelating agent helps keep compounds in solution which may otherwise precipitate out of solution under operational conditions. The role of the surfactant can be multifaceted. The surfactant may enhance the dissolution of CO₂ into the solution mixture, reactively absorb CO₂, facilitate the precipitation of sodium bicarbonate from solution, act as retardation agent, or perform a combination of these roles.

In some embodiments, the additive is a cationic surfactant. In some embodiments, the additive is a cationic surfactant selected from a list comprising Dodecyldimethylammonium chloride, Dodecyltrimethylammonium chloride, Tetrabutylammonium chloride, Tetramethylammonium fluoride tetrahydrate, Benzalkonium chloride, Benzyltriethylammonium chloride, Hexadecyltrimethylammonium chloride, Tetrabutylammonium hydrogen sulfate.

In some embodiments, the additive is an anionic surfactant. In some embodiments, the catalyst in an anionic surfactant selected from a list comprising Sodium dodecyl benzenesulfonate, Sodium dodecyl sulfate, Sodium laurate, Sodium laureth sulfate, Sodium lauroyl sarcosinate, Sodium myreth sulfate, Sodium nonanoyloxybenzenesulfonate, Sodium pareth sulfate, Sodium stearate, Sodium sulfosuccinate esters, Sodium tetradecyl sulfate, Magnesium laureth sulfate, 2-Acrylamido-2-methylpropane sulfonic acid, Alkylbenzene sulfonate, Ammonium lauryl sulfate, Ammonium perfluorononanoate, Disodium cocoamphodiacetate, Docusate, Perfluorobutanesulfonic acid, Perfluorohexanesulfonic acid, Perfluorononanoic acid, Perfluorooctanesulfonic acid, Perfluorooctanoic acid, Perfluoropropanesulfonic acid, Phospholipid, Potassium lauryl sulfate, Perfluorodecanoic acid.

In some embodiments, the weight percentage of additive in the solution mixture is in the range between about 10 ppm and about 20%. In some embodiments, the weight percentage of additive in the solution mixture is in the range between about 10 ppm and about 100 ppm. In some embodiments, the weight percentage of additive in solution mixture is in the range between about 100 ppm and about 1000 ppm. In some embodiments, the weight percentage of additive in the solution mixture is in the range between about 1000 ppm and about 1%. In some embodiments, the weight percentage of additive in the solution mixture is in the range between about 1% and about 10%. In some embodiments, the weight percentage of additive in the solution mixture is in the range between about 10% and about 20%.

In an exemplary embodiment, the additive sodium dodecyl benzenesulfonate as a surfactant promotes the precipitation of sodium bicarbonate from the solution mixture after the reactive absorption of CO₂ from the input gas mixture. In some embodiments, the concentration of sodium dodecyl benzenesulfonate in the solution mixture is in the range between about 50 ppm and about 500 ppm.

In some embodiments, the solution mixture comprises seed particles, the seed particles including at least one of sodium bicarbonate, calcium carbonate, magnesium carbonate, silica, an aluminosilicate, calcium silicate, magnesium silicate, or their combinations. In some embodiments, the seed particles enhance the rate of precipitation of sodium bicarbonate.

The input gas mixture 526 comprising CO₂ is flown into the reactor 530 at the bottom where it meets solution mixture 528 at the contactor or fill material 532. The sodium carbonate in the solution mixture 528 reactively absorbs the CO₂ in the input gas mixture 526 and water to from sodium bicarbonate.

As more CO₂ reacts with sodium carbonate in the solution mixture, the concentration of the sodium bicarbonate product increases in the solution. This results in formation of a precipitate comprising sodium bicarbonate. In some embodiments, beyond a threshold in concentration of sodium bicarbonate in solution, the sodium bicarbonate combines with sodium carbonate in solution to form sodium sesquicarbonate which may precipitate out of the solution. The sodium sesquicarbonate so formed may be either hydrated or non-hydrated. In some embodiments, the precipitate comprises at least one of sodium bicarbonate, sodium sesquicarbonate or a combination thereof. In some embodiments, the additive acts as a retardation agent to prevent the precipitation of sodium sesquicarbonate from solution.

In some embodiments, the input gas mixture 526 is ambient air. In some embodiments, the input gas mixture 526 is a flue gas stream from a power plant, or another industrial process. In some embodiments, the input gas mixture 526 is natural gas from an underground or geological natural gas reservoir comprising CO₂. In some embodiments, the input gas mixture 526 is the output of a Steam Methane Reforming process, an electrochemical process, blast furnace, steel making process, cement plant exhaust, or any other industrial process. In some embodiments, in addition to CO₂, the input gas mixture further comprises at least one of oxygen, nitrogen, natural gas, hydrogen, carbon monoxide, moisture, or combination thereof.

In some embodiments the CO₂ concentration in the input gas mixture 526 is between about 0.001% and about 90% by weight. In some embodiments the CO₂ concentration in the input gas mixture 526 is between about 0.01% and about 0.1% by weight. In some embodiments the CO₂ concentration in the input gas mixture 526 is between about 0.1% and about 1% by weight. In some embodiments the CO₂ concentration in the input gas mixture 526 is between about 1% and about 10% by weight. In some embodiments the CO₂ concentration in the input gas mixture 526 is between about 5% and about 20% by weight. In some embodiments the CO₂ concentration in the input gas mixture 526 is between about 5% and about 30% by weight. In some embodiments the CO₂ concentration in the input gas mixture 526 is between about 30% and about 90% by weight. In some embodiments, the input gas mixture 526 is ambient air. In some embodiments, the input gas mixture 526 is ambient air having a CO₂ concentration between about 0.03% and about 0.05% by weight. In some embodiments, the input gas mixture 526 is ambient air having a CO₂ concentration around 0.04% by weight.

When the input gas mixture is ambient air, the process of reactive absorption of CO₂ is a direct air capture process, and the method of sodium bicarbonate production becomes carbon negative since CO₂ is being pulled from the atmosphere (provided that the captured CO₂ in a subsequent step is stored or utilized without the release of the captured CO₂). When the input gas mixture is an exhaust of an industrial process, the method of sodium bicarbonate production provides for the carbon-neutrality of that industrial process as well as the sodium bicarbonate production (provided that the captured CO₂ in a subsequent step is stored or utilized without the release of the captured CO₂).

The reactor 530 for performing the reactive absorption of CO₂ from the input gas mixture 526 can be a carbonation tower, an absorption tower, an absorption column, a scrubber, a cooling tower, a continuous stirred tank reactor (CSTR), or another reactor suitable of gas/liquid reaction. While not explicitly shown, the reactor 530 may further include a fan or another device to enhance the flow of air through the reactor 530. In some embodiments, the process of reactive absorption is performed in a crossflow cooling tower. In some embodiments, the cooling tower has a drift eliminator to prevent the droplets of solution from being carried away by the air flow. In some embodiments, the cooling tower has a mechanical or electrical mechanism to prevent the drift of solution droplets under the effect of air flow.

For the reactor 530 shown in FIG. 5A, the fill material 532 provides a large surface area for reaction of CO₂ from the input gas mixture 526 with sodium carbonate in the solution mixture 528. While not shown explicitly in FIG. 5A, the reactor 530 includes an exit opening for the exit of the gas mixture after the reactive absorption of CO₂. In some embodiments, a fan may be placed at the exit opening of the reactor 530 to provide an enhanced flow of the gas mixture through the reactor 530.

The output solution 534 is collected from the bottom of the reactor 530 and filtered via sedimentation in a reservoir 536 as shown. Inside the reservoir 536 the solids comprising sodium bicarbonate settle to the bottom. The water in the top portion of the reservoir is collected and recycled into the solution mixture 528. In some embodiments, the filtration can be performed via any one of sedimentary filtration/separation, cyclone filtration, centrifugal filtration/separation, their combination or any other filtration or separation method.

FIG. 5B shows a process flow diagram of a continuous process for reactive absorption and mineralization of CO₂ from an incoming gas mixture into a solution comprising trona and a catalyst as shown in FIG. 5A. In this continuous process, the product formed by mineralization as a precipitate is filtered out and an additional trona solution is added to the initial solution mixture.

In the step 540, the trona solution 524 is mixed with a solution comprising a catalyst to form a solution mixture 528. The composition and other characteristics of the catalyst has been described in previous sections. The solution mixture 528 may further include an additive the description of which has been provided in previous sections. In some embodiments, the trona solution may further includes borate ions, arsenate ions, vanadate ions, or combinations thereof. In some embodiments, these ions in the trona solution may further enhance the rate of reactive absorption of CO₂ into the trona solution.

In the step 542, the solution mixture 528 is reacted with CO₂ in the input gas mixture 526 to form a suspension comprising a precipitate. The step 542 occurs is a reactor 530 which has been described in previous sections. In step 544, the suspension comprising the precipitate is filtered to remove at least a portion of the precipitate resulting in the formation of a filtered suspension that has lesser amount of precipitate particles in the suspension compared to the input. The filtration process can be performed in an industrial scale filtration system. The separation of precipitate particles from the suspension can be performed by sedimentation, centrifugal separation, membrane separation, flocculation, or electrostatic separation as described in previous sections.

In step 548, the precipitate so separated is collected and washed with a solvent to separate the catalyst and other impurities from the precipitate. The solvent is chosen such that it dissolves the catalyst but does not dissolve the sodium bicarbonate. In some embodiments, the solvent is an organic solvent miscible with water. In some embodiments, the solvent is at least one of ethanol, methanol, glycerol, ethylene glycol, propylene glycol propylene carbonate, or combinations thereof. In step 552, the washed solution comprising the dissolved catalyst is then recycled back to the solution mixture 528 while the washed precipitate is collected in step 550 to be either utilized or stored.

In step 546, the filtered suspension obtained after the filtration/separation step 544 is recycled into the solution mixture 528 to undergo further reactive absorption and mineralization of CO₂. A predetermined amount of the trona solution 524 is added to the solution mixture 528 in the step 554 to make up for the sodium bicarbonate that is formed in the step 542 due to the reactive absorption of CO₂ from the input gas mixture 526 into the solution mixture 528.

While not explicitly shown in the FIG. 5B, an additional amount of water may be added to the solution mixture 528 before the reactive absorption of CO₂ from the incoming gas mixture to make up for the water lost due to evaporation in the previous cycle. In some embodiments, when the step 542 is conducted with direct air in a cooling tower, a 0.5% to 5% loss of water by weight is expected due to evaporation and therefore, an equivalent amount of makeup water is added in the next cycle. The amount of water loss due to evaporation is dependent on a variety of factors such as temperature, humidity, pressure, air flow rate, specific surface area of fill material, flow rate of solution mixture etc.

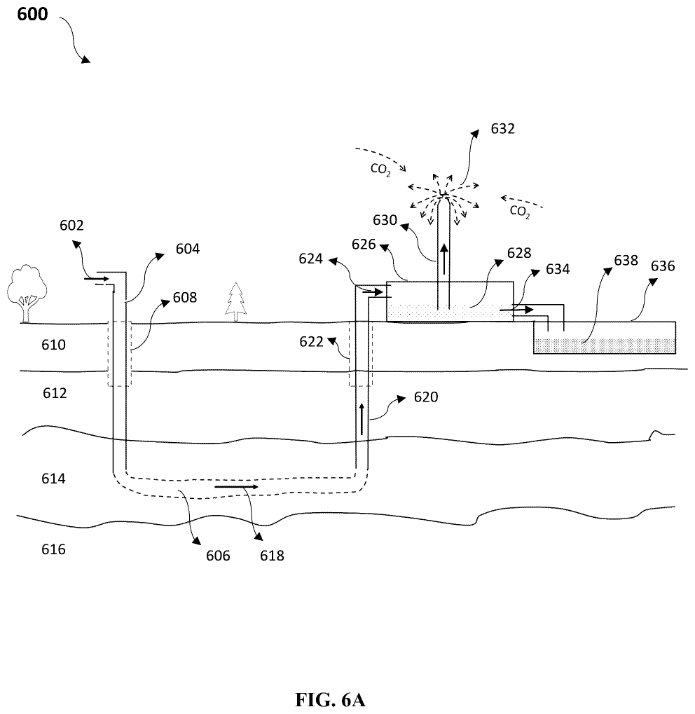

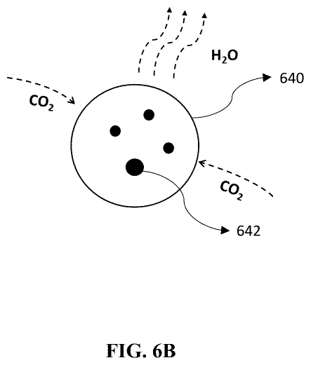

FIG. 6 shows another method of CO₂ capture and storage using trona. The method is similar to that shown in the FIG. 5, and the variation being the reactive absorption of CO₂ with trona solution done by spraying the solution mixture as an atomized droplets. The extracted fluid 624 from the solution mining operation is collected in a reservoir 626. While not explicitly shown, in some embodiments, a portion of the extracted fluid 624 from the solution mining operation is filtered upon extraction to remove a portion of the solids before entering the reservoir 626. The filtered trona solution is mixed with a catalyst and an additive to form a solution mixture 628. The solution mixture 628 in the reservoir 630 is pulled up from the reservoir via a pipe 630 up to a predetermined height.

According to the embodiment shown, the solution mixture 628 is then sprayed into the open air to absorb the CO₂ from the air causing reactive absorption of CO₂ from the air into the solution mixture 628. The CO₂ from the air reacts with the sodium carbonate in solution mixture 628 and water to form sodium bicarbonate which precipitates from the solution mixture 628 which along with the sprayed solution is collected in the reservoir. The repeated spraying of the solution or slurry in the solution leads to a complete conversion or near-complete conversion of sodium carbonate in the solution of sodium bicarbonate precipitate. The solid slurry 634 comprising sodium bicarbonate that settles at the bottom of the reservoir 626 is collected and stored in another reservoir 636. Inside the reservoir the solids comprising sodium bicarbonate 638 settle to the bottom. In some embodiments, the water in the top portion of the reservoir is collected and reused in the process.

The elements of the solution mining operation 602 to 624 are substantially similar to the corresponding elements 502 to 524 described in previous sections. The solution mixture 628 is substantially similar to the solution mixture 528 described in previous sections along with all its variations. The key characteristics of composition, temperature, pressure and phase of the solution mixture 628, and the trona solution 624, the catalyst and the additives that are included in the solution mixture 628 are the same as that described for the solution mixture 528, trona solution 524, and the catalyst and additives in previous sections respectively along with their variations.

A key aspect of this process is the spraying of solution mixture 628 which atomizes the solution mixture into small droplets 632 with droplet size in the range between about 0.01 microns and about 500 microns. As a result, the surface area of the solution mixture increases substantially thus enhancing the rate of reactive absorption of the CO₂ from air with the solution mixture.

FIG. 6B shows an individual droplet 640 of the sprayed solution mixture 632 shown in previous figure. The droplet 640 includes particles 642 of the sodium bicarbonate precipitate formed by the reactive absorption of the CO₂ from the surrounding air with the solution mixture 628.

In some embodiments, the spraying process as shown in FIG. 6A is done in an enclosure to prevent drift of the droplets. In some embodiments, air is blown through the enclosure by means of a fan. In some embodiments, the reactor 530 for the process shown in FIG. 5A includes a spraying mechanism to produce atomized droplets. In some embodiments, the process shown in FIG. 6A is done for other input gas mixtures comprising CO₂ in a percentage range between about 0.01% and about 90% by weight.

In some embodiments, the large surface area created due to the atomized droplets may enhance the dissolution of CO₂ present in the air (or input gas mixture) into the solution mixture. In some embodiments, the large surface area created due to the atomized droplets may enhance the reaction of CO₂ present in the air (or input gas mixture) into the solution mixture. In some embodiments, the large surface area created due to the atomized droplets may enhance the precipitation of the sodium bicarbonate formed after the reaction.

In some embodiments, the evaporation of water or other solvent in the atomized droplets causes a reduction in mass and volume of the droplets leading to an increase in concentration of solution in atomized droplets which in turn leads to the precipitation process. In some embodiments, the precipitation process occurs in atomized droplets is due to lowering of temperature of the droplet due to evaporation of the water or solvent in the solution mixture. In some embodiments, the precipitation behavior is different in the atomized droplets compared to the precipitation in bulk solution mixture or thin layers of solution mixture due to nanoscale effects caused by the small size of the droplets. In some embodiments, the surface tension in the nanoscale droplets leads to enhanced absorption, enhanced reaction, and/or enhanced precipitation of reaction product within the droplet.

In some embodiments, the atomized droplets 640 are in the size range between about 0.01 microns and about 1000 microns. In some embodiments, the atomized droplets 640 are in the size range between about 0.01 microns (10 nm) and about 0.1 microns (100 nm). In some embodiments, the atomized droplets of 640 are in the size range between about 0.01 microns and about 1 micron. In some embodiments, the atomized droplets 640 are in the size range between about 0.1 microns and about 10 microns. In some embodiments, the atomized droplets 640 are in the size range between about 1 micron and about 10 microns. In some embodiments, the atomized droplets 640 are in the size range between about 1 micron and about 100 microns. In some embodiments, the atomized droplets 640 are in the size range between about 10 microns and about 100 microns. In some embodiments, the atomized droplets 640 are in the size range between about 100 microns and about 500 microns. In some embodiments, the atomized droplets 640 are in the size range between about 500 microns and about 1000 microns.

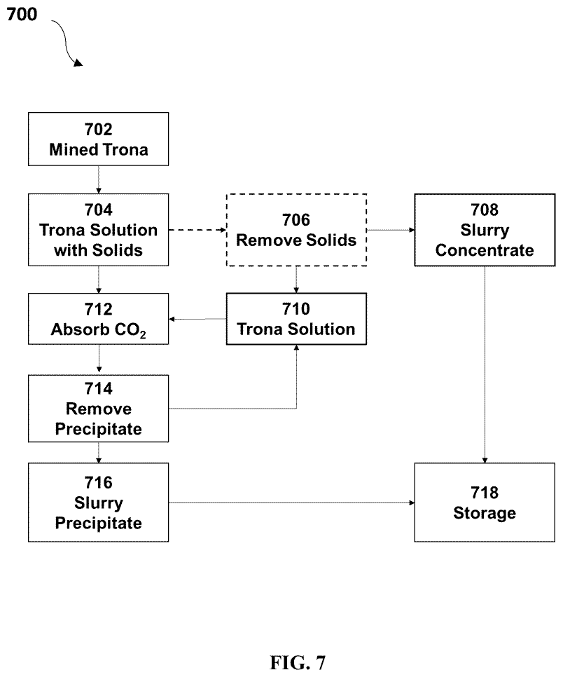

FIG. 7 shows another a block diagram of reactive absorption and chemical storage of CO₂ in mined trona to form sodium bicarbonate which is stored or used as such. In some embodiments, the mined trona 702 is a solid which is mined using conventional mining techniques such as room and pillar mining, longwall mining or dredging method. In some embodiments, the mined trona 702 is solution mined in which case the trona is already a solution or slurry comprising sodium carbonate and sodium bicarbonate both in solution and/or solids along with other insoluble impurities.

When the mined trona 702 is a solid, it is dissolved in water to prepare a trona solution 704 with may still contain solids. These solids may be present as insoluble impurities or as a soluble material in concentration beyond the solubility limit. In some embodiments, one such soluble material in concentration beyond the solubility limit is sodium bicarbonate. At step 706 the solids are removed from the trona solution and the slurry concentrate 708 obtained after the removal are stored (Step 718).

In step 712, CO₂ is then absorbed and reacted with the solution 704 to form sodium bicarbonate. Additionally, the filtered solution 710 after removal of solids is also passed to step 712 to absorb and react CO₂ with it. In some embodiments, the sodium bicarbonate so formed precipitates out of the solution. In some embodiments, the sodium bicarbonate remains dissolved in the solution. In this case, the solution is evaporated (not shown) to precipitate the sodium bicarbonate. In step 714 the precipitated sodium carbonate is removed from the solution as a slurry precipitate 716 which is sent to storage at step 718. The solution left behind after step 714 may be recycled back to the trona dissolution step to form trona solution with solids 704.

In some embodiments the trona solution can be formed in a solvent other than water. In some embodiments, the trona solution is formed in an organic solvent. In some embodiments the organic solvent is at least one of glycerol, ethylene glycol, ethanol, methanol, propylene glycol, acetone or another ketone. In some embodiments the step 712 is performed without dissolving the mined trona solution in a solvent. In some embodiments, the mined trona is a solid. In some embodiments, the mined trona is crushed into powder and reacted with CO₂. In some embodiments the particle size of the crushed trona is between about 0.1 micron and about 1 mm.

In some embodiments, the mined trona in solid state is reacted with CO₂ and H₂O in vapor phase. In some embodiments, the as mined trona in solid state is reacted with CO₂ and H₂O in liquid phase. In some embodiments, the as mined trona in solid state is reacted with CO₂ and H₂O (in vapor phase) at a temperature between ambient temperature and about 100° C. In some embodiments, the mined trona is reacted with a mixture of gases comprising CO₂ and steam. In some embodiments, the steam is at a temperature between about 100° C. and about 500° C. In some embodiments, the temperature of the mixture of gases comprising CO₂ and H₂O is between ambient temperature and about 500° C.

In some embodiments, the mined trona is reacted with flue gases from a coal power plant, natural gas power plant or another industrial process. In some embodiments, the flue gases are combined with water vapor or steam before reacting with as mined trona. In some embodiments, the mined trona in solid state is reacted with a mixture of CO₂ and H₂O at high pressure. In some embodiments, a pressure between about 0.1 MPa to about 10 MPa is maintained during reaction between mined trona in solid state and the mixture of gases comprising CO₂ and H₂O. In some embodiments the mixture of gases used to react with as mined trona comprise at least one of CO₂, SO₂, SO₃, NO, NO₂, 02, N₂ and H₂O. In some embodiments, the step 712 of absorbing and reacting with CO₂ in ambient air.

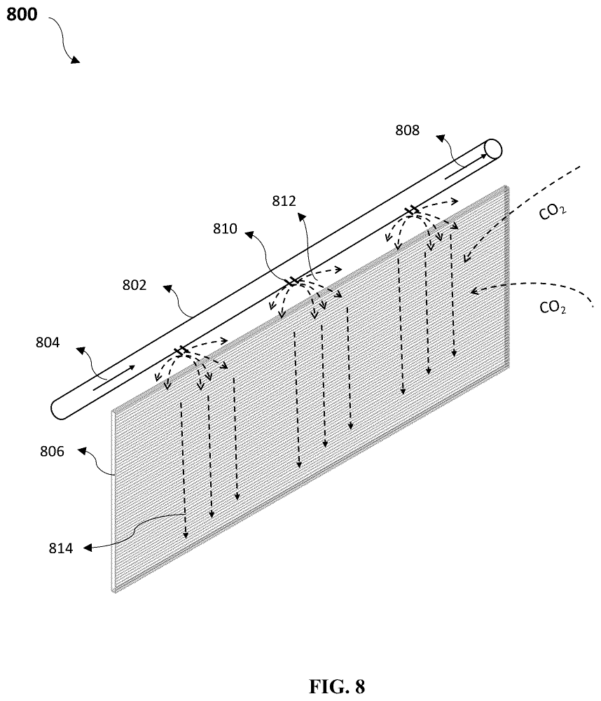

FIG. 8 shows a method of Direct Air Capture of CO₂ with a solution comprising trona. The method involves flowing a solution 804 through a tube 802 with a plurality of openings 810, the openings attached with nozzles attached to spray the solution flowing into the tube 802. The sprayed solution 812 hits a screen 806 allowing the solution to trickle downward on the screen.

In some embodiments, the solution 804 comprises sodium carbonate and sodium bicarbonate. In some embodiments the solution comprises sodium carbonate only. In some embodiments, the solutions 804 comprises solid particles forming a suspension. In some embodiments, the solid particles include insoluble compounds. In some embodiments, the solid particles include sodium bicarbonate. In some embodiments the solid particles have a particle size in the range between about 0.1 microns and about 1 mm. In some embodiments, the solution 804 has a high weight percentage of solid particles thereby forming a slurry. In some embodiments, the solution 804 comprises sodium chloride. In some embodiments, the solution 804 comprises sodium tetraborate. In some embodiments, the solution 804 is a solution of as-mined trona in solid form. In some embodiments, the solution 804 comprises solution mined trona. In some embodiments, the solution 804 is a suspension comprising metal silicate compound and solution mined trona.

In some embodiments, the solution 804 comprises a catalyst. In some embodiments, the composition, phase, temperature, pressure of the catalyst is the same as that described for the catalyst described for FIG. 5A including all the described variations. In some embodiments, solution 804 comprises additives. In some embodiments, solution 804 comprises are at least one of sodium chloride, sodium tetraborate, potassium chloride, potassium tetraborate, Calcium Chloride, Magnesium Chloride, or another ionic salt. In some embodiments, the additive comprises an ionic liquid. In some embodiments the ionic liquid additive enhances the dissolution of CO₂ into the solution 804. In some embodiments, the additives enhance the solubility of CO₂ in the solution 804.

In some embodiments, the concentration of additives in the solution 804 is between about 50 ppm and about 200,000 ppm by weight. In some embodiments, the solution 804 comprises insoluble solids as additives. In some embodiments, the insoluble solid additives include at least one of calcium carbonate, magnesium carbonate, lithium carbonate, iron carbonate, iron oxide, hematite, magnetite or another oxide powder. In some embodiments, the insoluble solid additives act as seed particles for precipitation of sodium bicarbonate from the solution. In some embodiments, the insoluble solid additives act as a catalyst for the precipitation of sodium bicarbonate from the solution.

The trickled solution 814 absorbs CO₂ from the air and reacts with it to form an insoluble product. In some embodiments, sodium carbonate in the solution 814 reacts with CO₂ to form sodium bicarbonate. In some embodiments, the sodium bicarbonate so formed precipitates out of the solution. In some embodiments, the sodium bicarbonate so formed remains in solution. In some embodiments the precipitated sodium bicarbonate is separated from the solution. In some embodiments, filtered solution after removal of precipitates is recycled again through tube 802 as solution 804 to repeat the process. In some embodiments, the filtered solution after removal of precipitates is mixed with fresh trona solution to form solution 804 to be flown through the tube 802.

In some embodiments the sprayed solution 812 and trickled solution 814 is naturally exposed to the ambient air to absorb and react with CO₂. In some embodiments, external air flow is incident on screen 806 to provide and accelerated dissolution and reaction of CO₂ in the air with the sprayed solution 812 and trickled solution 814. In some embodiments, the external air flow is created by operating a fan through an array of screens 806 having solution 804 trickling through it due to the solution sprayed from an array of pipes 802.

In some embodiments, the external air flow is parallel the to the plane of the screen 806 in vertically upwards direction (counter flow configuration). In some embodiments, the external air flow is parallel to the plane of the screen 806 in a sideways direction along the plane of the screen 806 (crossflow configuration). In some embodiments, the external air flow is orthogonal to the plane of the screen 806. In some embodiments, the screen 806 is porous allowing the orthogonal air flow to pass through the screen. In some embodiments, the external air flow is created using fans. In some embodiments, the process is FIG. 8 is performed in an enclosed environment.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of geological CO₂ storage by in-situ mineralization, the method comprising:
injecting CO₂ and H₂O into a geological formation of a mineral comprising trona,
wherein the H₂O dissolves a portion of the mineral comprising trona to form a solution comprising sodium carbonate,
and wherein the CO₂ reacts with the sodium carbonate in the solution to form sodium bicarbonate in-situ.

2. The method of claim 1, wherein CO₂ and H₂O are injected together as a mixture.

3. The method of claim 1, wherein CO₂ and H₂O are injected in alternate cycles.

4. The method of claim 1, wherein CO₂ and H₂O are injected using different pipes to avoid corrosion.

5. The method of claim 1, wherein CO₂ and H₂O are injected using same pipe.

6. The method of claim 1, wherein the at least one of CO₂ and H₂O are injected at an injection pressure in the range between about 0.1 MPa and about 1000 MPa.

7. The method of claim 1, wherein the at least one of CO₂ and H₂O are injected at an injection pressure in the range between about 0.5 MPa and about 10 MPa.

8. The method of claim 1, wherein the sodium bicarbonate formed in-situ is extracted to the surface as a slurry or a suspension.

9. The method of claim 8, wherein the sodium bicarbonate extracted to the surface is stored at a secondary location.

10. A method of carbon capture and mineralization, the method comprising:
solution mining a mineral comprising trona to form a trona solution, wherein the trona solution includes sodium carbonate dissolved in it; and
reacting an input gas mixture comprising CO₂ with the trona solution in a reactor to form a suspension comprising a precipitate of sodium bicarbonate.

11. The method of claim 10, wherein a catalyst is added to the trona solution before reacting the input gas mixture comprising CO₂ with the trona solution.

12. The method of claim 11, wherein the catalyst includes at least one of an amine, an amino acid, an amino acid salt, an ionic salt, an organic salt, an ionic liquid, a borate compound, an arsenate compound, a vanadium compound, a vanadate compound, a cuprous compound, a cupric compound, carbonic anhydrase, an organometallic compound, a surfactant, or combinations thereof.

13. The method of claim 10, wherein an additive is added to the trona solution before reacting the input gas mixture comprising CO₂ with the trona solution.

14. The method of claim 13, wherein the additive includes an anionic surfactant added to enhance the precipitation of sodium bicarbonate.

15. The method of claim 10, wherein the percentage of CO₂ in the input gas mixture is in the range between about 0.01% and about 90% by weight.

16. The method of claim 10, wherein the input gas mixture comprising CO₂ is at least one of flue gas emission from a power plant, emission from an industrial process, or natural gas from a natural gas reservoir.

17. The method of claim 10, wherein the reactor includes at least one of a carbonation tower, an absorption tower, a scrubber, a cooling tower, a continuous stirred tank reactor, or another reactor suitable for reaction between a gas and a liquid.

18. The method of claim 10, further comprising a filtration step to separate the precipitate of sodium bicarbonate from the suspension.

19. The method of claim 10, wherein the sodium bicarbonate precipitate is stored in a surface reservoir, an underground reservoir, an underground cavern, an abandoned oil and gas well, an empty coal mine, an empty trona mine, or another underground formation.

20. A method of carbon capture and mineralization, the method comprising:
dissolving a mineral comprising trona in water to form a trona solution, wherein the trona solution includes sodium carbonate dissolved in it;
mixing the trona solution with a solution comprising a catalyst to form a solution mixture; and
reacting ambient air comprising CO₂ with the solution mixture to form a precipitate, the precipitate including at least one of sodium bicarbonate, sodium sesquicarbonate, or their combination.

21. The method of claim 20, wherein the catalyst includes at least one of an amine, an amino acid, an amino acid salt, an ionic salt, an organic salt, an ionic liquid, a borate compound, an arsenate compound, a vanadium compound, a vanadate compound, a cuprous compound, a cupric compound, carbonic anhydrase, an organometallic compound, a surfactant, or combinations thereof.

22. The method of claim 20, further comprising a filtration step to separate the precipitate from the trona solution.

23. The method of claim 22, wherein the precipitate is stored in a surface reservoir, an underground reservoir, an underground cavern, an abandoned oil and gas well, an empty coal mine, an empty trona mine, or another underground formation.

24. A carbon negative sodium bicarbonate produced by a chemical reaction between sodium carbonate from a trona solution and CO₂ from ambient air.
